(19) United States
(12) Patent Application Publication
(10) Pub. No.: US 2026/0088325 A1
(43) Pub. Date: Mar. 26, 2026

(54) Secondary Battery Manufacturing Equipment and Secondary Battery Manufacturing Method

(71) Applicant: SK On Co., Ltd., Seoul (KR)

(72) Inventors: Yoon Sung OH, Seoul (KR); Jin Ah SON, Seoul (KR)

(21) Appl. No.: 19/267,760

(22) Filed: Jul. 14, 2025

(30) Foreign Application Priority Data
Sep. 26, 2024 (KR) 10-2024-0130648

(51) Int. Cl. H01M 10/04; B29C 65/32; B29L 31/34; H01M 50/105; H01M 50/186; H01M 50/533

(52) U.S. Cl. CPC H01M 10/0404; B29C 65/32; H01M 50/186; H01M 50/533; B29L 2031/3468; H01M 50/105

(57) ABSTRACT

Provided are secondary battery manufacturing equipment and a secondary battery manufacturing method. According to an aspect of the present disclosure, secondary battery manufacturing equipment which includes a sealing device configured to press an pouch film to seal a sealing region in which an electrode tab is disposed, an induction heating coil configured to inductively heat the electrode tab to provide heat to the sealing region in an outer region of the electrode tab disposed outside the pouch film, and a first guide configured to press and support the electrode tab in a direction opposite to the induction heating coil to limit movement of the electrode tab caused by a magnetic field when the electrode tab is inductively heated.

### CROSS-REFERENCE TO RELATED APPLICATION

This application claims priority to and the benefit of Korean Patent Application No. 10-2024-0130648, filed on Sep. 26, 2024, the disclosure of which is incorporated herein by reference in its entirety.

### BACKGROUND

### 1. Field of the Invention

Embodiments of the present disclosure relate to secondary battery manufacturing equipment and a secondary battery manufacturing method.

### 2. Discussion of Related Art

A secondary battery is one type of energy storage device that can be charged and discharged through an electrochemical reaction. Secondary batteries may be utilized in various fields in which electrical energy is used. For example, secondary batteries are being widely used in the field of mobile devices such as mobile phones, notebooks, tablets, etc., and their wider use is being sought in the field of transportation such as vehicles, aircraft, ships, etc. Further, demand for secondary batteries is increasing in the field of energy storage systems (ESS) for utilizing surplus electricity.

Some secondary batteries may be packaged using a flexible film-type pouch film. Such secondary batteries may be referred to as pouch-type batteries, pouch-type cells, etc., in the art. In a pouch-type secondary battery, an electrode assembly may be accommodated in an interior of an pouch film together with an electrolyte. Further, the pouch film in which the electrode assembly and the like are disposed may be sealed by bonding all edges thereof.

### SUMMARY OF THE INVENTION

Embodiments of the present disclosure are directed to providing secondary battery manufacturing equipment and a secondary battery manufacturing method. Some embodiments of the present disclosure are also directed to providing secondary battery manufacturing equipment and a secondary battery manufacturing method that are capable of appropriately sealing between an pouch film and an electrode tab.

Some embodiments of the present disclosure are also directed to providing secondary battery manufacturing equipment and a secondary battery manufacturing method that are capable of sealing between an pouch film and an electrode tab through induction heating.

Some embodiments of the present disclosure are also directed to providing secondary battery manufacturing equipment and a secondary battery manufacturing method that are capable of reducing surface damage to an electrode tab during a sealing process.

Some embodiments of the present disclosure are also directed to providing secondary battery manufacturing equipment and a secondary battery manufacturing method that are capable of improving the quality of sealing between an pouch film and an electrode tab.

Some embodiments of the present disclosure may be widely applied in the fields of electric vehicles, battery charging stations, and green technology such as solar power generation and wind power generation using batteries. Further, some embodiments of the present disclosure may be used in eco-friendly electric vehicles, hybrid vehicles, etc., to prevent climate change by suppressing air pollution and greenhouse gas emissions.

According to an aspect of the present disclosure, there is provided secondary battery manufacturing equipment which includes a sealing device configured to press an pouch film to seal a sealing region in which an electrode tab is disposed, an induction heating coil configured to inductively heat the electrode tab to provide heat to the sealing region in an outer region of the electrode tab disposed outside the pouch film, and a first guide configured to press and support the electrode tab in a direction opposite to the induction heating coil to limit movement of the electrode tab caused by a magnetic field when the electrode tab is inductively heated.

In some embodiments, the electrode tab may include an inner region disposed inside the pouch film to correspond to the outer region, and the sealing region may be formed in the inner region.

In some embodiments, the sealing device may be formed to press a sealing material disposed between the electrode tab and the pouch film in the sealing region, and at least a portion of the sealing material may be melted by the heat transmitted from the electrode tab.

In some embodiments, the sealing device may include a first sealing bar that presses the sealing region in a first direction according to a thickness direction of the pouch film, and a second sealing bar that presses the sealing region in a second direction opposite to the first direction to correspond to the first sealing bar.

In some embodiments, the induction heating coil may be disposed to be spaced a predetermined gap from one surface of the outer region.

In some embodiments, the induction heating coil may form a heating region when viewed from above, and the heating region may be disposed on an inner side of the outer region when viewed from above.

In some embodiments, the first guide may be formed to be movable in a direction approaching an outer surface of the electrode tab or in a direction away from the outer surface of the electrode tab.

In some embodiments, the first guide may include a pressing surface that comes into contact with the electrode tab to support the electrode tab, and the pressing surface may be formed to extend in a width direction according to a width direction of the electrode tab, from an end portion at one side of the electrode tab to an end portion at the other side.

In some embodiments, the first guide may be formed to press and support the electrode tab before a current is applied to the induction heating coil.

In some embodiments, the secondary battery manufacturing equipment may further include a second guide that is disposed to face the first guide with the outer region interposed therebetween and supports the outer region between the first guide and the second guide.

In some embodiments, the second guide may be disposed between the outer region and the induction heating coil to determine a gap between the outer region and the induction heating coil.

In some embodiments, the second guide may include an opening through which a magnetic field of the induction heating coil approaches the outer region.

In some embodiments, the secondary battery manufacturing equipment may further include a temperature measurement portion configured to measure a temperature of the electrode tab in real time while performing induction heating.

In some embodiments, the temperature measurement portion may include a plurality of temperature measurement units disposed on the first guide, and the plurality of temperature measurement units may be disposed to measure the temperature of the electrode tab in each of different measurement regions when viewed from above.

In some embodiments, the temperature measurement portion may include an insulating wall that is disposed between the respective temperature measurement units and insulates the respective temperature measurement units from each other.

In some embodiments, the temperature measurement portion may include one or more temperature measurement units, and the temperature measurement units may include a heat-conducting portion having a first contact surface in contact with the electrode tab, a heat-insulating portion that has a second contact surface corresponding to the first contact surface and insulates the electrode tab from the heat-conducting portion, and a temperature sensor that is embedded in the heat-conducting portion and measures a temperature of the heat-conducting portion.

In some embodiments, the temperature measurement portion may include a plurality of temperature measurement units, any one of the plurality of temperature measurement units may include the first contact surface provided at a predetermined position when viewed from above, and another one of the plurality of temperature measurement units may include the first contact surface at a different position from the predetermined position when viewed from above.

According to an aspect of the present disclosure, there is provided a secondary battery manufacturing method which includes an operation (a) of arranging an electrode assembly inside an pouch film, an operation (b) of inductively heating an electrode tab using an induction heating coil disposed in an outer region while a first guide presses and supports the outer region of the electrode tab, and an operation (c) of pressing and sealing a sealing region disposed inside the pouch film simultaneously or sequentially along with the operation (b).

In some embodiments, the operation (b) may include an operation of supporting the outer region between the first guide and a second guide corresponding to the first guide, and the operation (b) may include an operation of providing a magnetic field for induction heating to the outer region through an opening provided in the second guide.

In some embodiments, the operation (b) may include an operation of supporting the outer region between the first guide and the second guide corresponding to the first guide, and the operation (b) may include an operation of inductively heating the electrode tab while the second guide maintains a gap between the outer region and the induction heating coil.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a view illustrating a secondary battery according to one embodiment;

FIG. 2 is a partial cross-sectional view of the secondary battery illustrated in FIG. 1;

FIG. 3 is a schematic side view illustrating a secondary battery manufacturing device according to one embodiment of the present disclosure;

FIG. 4 is a schematic plan view of an induction heating coil illustrated in FIG. 3;

FIG. 5 is a schematic perspective view illustrating first and second guides disposed in the secondary battery manufacturing device illustrated in FIG. 3;

FIG. 6 is a schematic perspective view illustrating operations of the first and second guides illustrated in FIG. 5;

FIG. 7 is a schematic front view illustrating the first and second guides illustrated in FIG. 6;

FIG. 8 is a schematic side view illustrating a temperature measurement portion according to one embodiment of the present disclosure;

FIG. 9 is a schematic bottom view of the temperature measurement portion illustrated in FIG. 8 as viewed from below;

FIG. 10 is a schematic plan view illustrating a region measured by the temperature measurement portion illustrated in FIG. 9; and

FIG. 11 is a schematic process diagram illustrating a secondary battery manufacturing method according to one embodiment of the present disclosure.

### DETAILED DESCRIPTION OF EXEMPLARY EMBODIMENTS

Hereinafter, the present disclosure will be described in detail with reference to the accompanying drawings. However, this is only exemplary, and the present disclosure is not limited to specific embodiments that are described as exemplary.

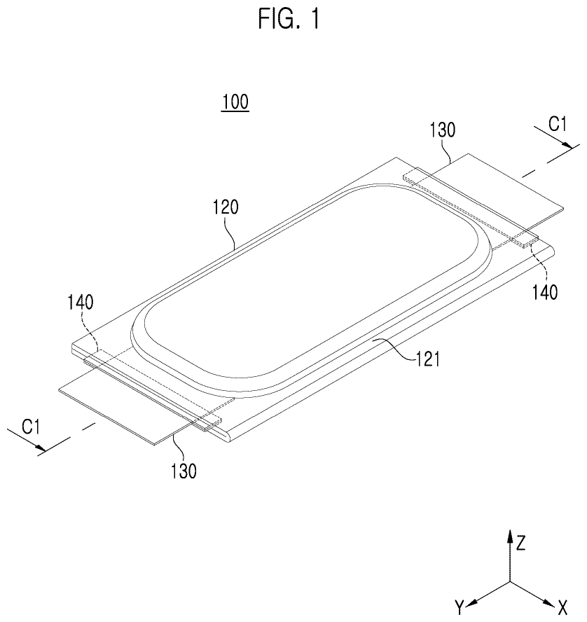

FIG. 1 is a view illustrating a secondary battery according to one embodiment.

Referring to FIG. 1, a secondary battery manufacturing device 200 according to embodiments of the present disclosure may be used to manufacture a secondary battery 100. In some embodiments, the secondary battery 100 may include an electrode assembly 110, and the electrode assembly 110 may be provided to be accommodated in an interior of a flexible film-shaped pouch film 120. Such a secondary battery 100 may be referred to in the art as a pouch-type battery, a pouch-type cell, etc. In some embodiments, the secondary battery manufacturing device 200 may be appropriately used for a secondary battery 100 having a pouch-type form factor. Specifically, the secondary battery manufacturing device 200 may be used to seal between an pouch film 120 and an electrode tab 130 in the secondary battery 100 having the pouch-type form factor.

However, the secondary battery manufacturing device 200 according to embodiments of the present disclosure is not necessarily limited to typical pouch-type batteries and the like. In some cases, the secondary battery manufacturing device 200 may be utilized in various packaging methods in which an pouch film 120 or a packaging case with similar characteristics to the pouch film 120 is used. Further, in some cases, the secondary battery manufacturing device 200 may be utilized or applied in various non-typical packaging methods that are not specified or named.

With respect to mainly describing the illustrated pouch-type secondary battery 100, the secondary battery 100 may include an pouch film 120 in which an electrode assembly 110 is accommodated. In some embodiments, the pouch film 120 may be provided as a multilayer film. For example, the pouch film 120 may include a metal layer such as aluminum or the like and a resin layer adhered to an inner and/or outer surface of the metal layer. In some embodiments, the pouch film 120 may be provided by bonding edges of a film material. For example, the pouch film 120 may be provided by folding one film material in half and bonding edges thereof or by placing a two-layer film material so that the two layers of the film material in contact with each other and bonding edges thereof. Such an pouch film 120 may have a space formed therein in which the electrode assembly 110 can be accommodated and have a bonding region 121 provided along the edges.

Meanwhile, the secondary battery 100 may include an electrode tab 130. In some embodiments, the electrode tab 130 may be provided as a pair of electrode tabs 130. One of the pair of electrode tabs 130 may function as a positive electrode tab or a negative electrode tab, and the other may function as a negative electrode tab or a positive electrode tab corresponding to the positive electrode tab or the negative electrode tab. For convenience, in this description, the positive electrode tab or the negative electrode tab is collectively referred to as the electrode tab 130.

In some embodiments, the electrode tab 130 may be disposed on an edge portion of the pouch film 120. Further, the pair of electrode tabs 130 may be disposed at different positions on the edge portion of the pouch film 120. For example, in the illustrated embodiment, one electrode tab 130 may be disposed on one short side portion of the pouch film 120, and the other electrode tab 130 may be disposed on an opposite short side portion corresponding to the short side portion. However, the arrangement of the electrode tabs 130 is not particularly limited in the embodiments of the present disclosure.

In some embodiments, at least a portion of the electrode tab 130 may be exposed to the outside of the pouch film 120. Accordingly, the electrode tab 130 may function as an electrical connection path between the electrode assembly 110 disposed inside the pouch film 120 and the outside of the pouch film 120. Further, the electrode tab 130 extending inside and outside of the pouch film 120 may be sealed by a sealing region 140. The sealing region 140 may be formed by bonding the edge portions of the pouch film 120 to both surfaces of the electrode tab 130.

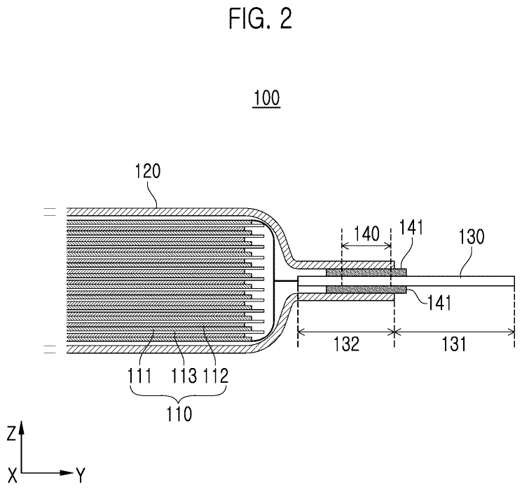

FIG. 2 is a partial cross-sectional view of the secondary battery illustrated in FIG. 1. FIG. 2 illustrates a schematic cross-section of a portion of the electrode tab indicated by line C1-C1 in FIG. 1.

Referring to FIG. 2, in some embodiments, the secondary battery 100 may include an electrode assembly 110 accommodated in an interior of an pouch film 120. In some embodiments, the electrode assembly 110 may include first and second electrodes 111 and 112 disposed with a separator 113 interposed therebetween. The first electrode 111 may be a positive electrode or a negative electrode, and the second electrode 112 may be a negative electrode or a positive electrode corresponding to the positive electrode or the negative electrode. In some embodiments, the electrode assembly 110 may be provided in a structure in which the first and second electrodes 111 and 112 disposed with the separator 113 interposed therebetween are stacked or wound. However, a detailed configuration of the electrode assembly 110 is not particularly limited in the embodiments of the present disclosure.

Meanwhile, the secondary battery 100 may include an electrode tab 130. In some embodiments, the electrode tab 130 may be formed to extend inside and outside of the pouch film 120. In other words, the electrode tab 130 may include an outer region 131 disposed outside the pouch film 120 and an inner region 132 disposed inside the pouch film 120. The electrode tab 130 may be bonded to the pouch film 120 in the inner region 132 to form a sealing region 140. The sealing region 140 may function to seal between the pouch film 120 and the electrode tab 130. In some embodiments, a sealing material 141 may be provided between the electrode tab 130 and the pouch film 120, and the sealing region 140 may be formed in an inner region of the sealing material 141.

In some embodiments, the electrode tab 130 may be electrically connected to the electrode assembly 110 inside the pouch film 120. In other words, the inner region 132 of the electrode tab 130 may be electrically connected to the first electrode 111 or the second electrode 112 inside the pouch film 120.

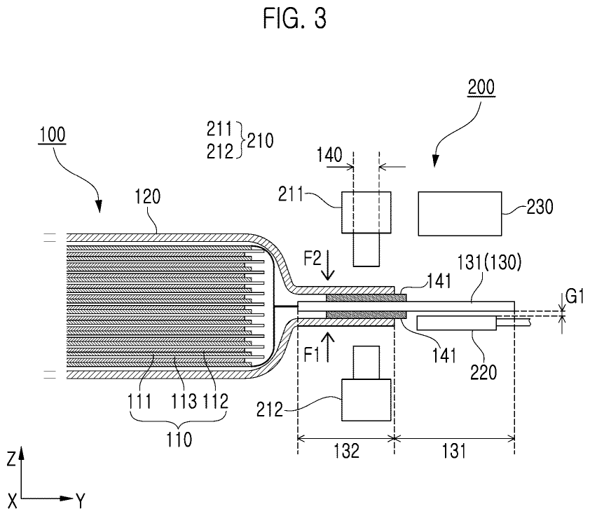

FIG. 3 is a schematic side view illustrating a secondary battery manufacturing device according to one embodiment of the present disclosure.

For convenience of description, in the following, based on axes of coordinates illustrated in FIG. 3, an x-axis direction is referred to as a left-right direction, a y-axis direction is referred to as a front-rear direction, and a z-axis direction is referred to as an up-down direction. For reference, in the illustrated embodiment, the secondary battery 100 as illustrated in FIG. 1 is disposed such that a pair of electrode tabs 130 are disposed to be spaced apart from each other in the y-axis direction, and among the pair of electrode tabs 130, only one electrode tab 130 corresponding to a right side on the drawing is exemplarily illustrated.

Meanwhile, for convenience of description, it is noted that in the drawings below including FIG. 3, each component of a secondary battery manufacturing device 200 is partially omitted or exaggerated.

Referring to FIG. 3, in some embodiments, the secondary battery manufacturing device 200 may be used to seal and process between the pouch film 120 and the electrode tab 130. In other words, the secondary battery 100 may be provided in a state in which the pouch film 120, the sealing material 141, and the electrode tab 130 are temporarily assembled as illustrated in FIG. 2, and the secondary battery manufacturing device 200 may be used to seal between the pouch film 120 and the electrode tab 130 in the temporarily assembled state of the secondary battery 100.

In some embodiments, the secondary battery manufacturing device 200 may include a sealing device 210 that presses the pouch film 120 to seal the sealing region 140 in which the electrode tab 130 is disposed, an induction heating coil 220 that inductively heats the electrode tab 130 in the outer region 131 of the electrode tab 130 disposed outside the pouch film 120 to provide heat to the sealing region 140, and a first guide 230 that presses and supports the electrode tab 130 in a direction facing the induction heating coil 220 to limit movement of the electrode tab 130 caused by a magnetic field when the electrode tab 130 is inductively heated.

Specifically, in some embodiments, the secondary battery manufacturing device 200 may include the sealing device 210. The sealing device 210 may be provided to press the pouch film 120 to seal the sealing region 140 in which the electrode tab 130 is disposed. In some embodiments, the sealing device 210 may be provided to press the sealing material 141 disposed between the electrode tab 130 and the pouch film 120 and seal the sealing region 140. The sealing material 141 may be disposed between an inner surface of the pouch film 120 and an outer surface of the electrode tab 130. The sealing material 141 may be provided on one surface and/or both surfaces of the electrode tab 130 to bond or seal the electrode tab 130 and the pouch film 120. For example, in the illustrated embodiment, the sealing material 141 may be provided on an upper surface and a bottom surface of the electrode tab 130 to bond or seal the electrode tab 130 and the pouch film 120. A specific type of the sealing material 141 is not particularly limited in the embodiments of the present disclosure. For example, the sealing material 141 may include a thermoplastic resin such as polypropylene, polyethylene, or the like.

In some embodiments, the sealing material 141 may be pressed by the sealing device 210 while being appropriately heated and melted. In some embodiments, the sealing material 141 may be heated and melted at an appropriate bonding temperature through the induction heating coil 220 which will be described below.

In some embodiments, the sealing device 210 may include a first sealing bar 211 and a second sealing bar 212. The first and second sealing bars 211 and 212 may be disposed to be spaced apart from each other with the sealing region 140 interposed therebetween. In the illustrated embodiment, the first and second sealing bars 211 and 212 may be disposed to be spaced apart from each other vertically with the sealing region 140 interposed therebetween. The first sealing bar 211 may be formed to press the sealing region 140 in a first direction F1 according to a thickness direction of the pouch film 120. In the illustrated embodiment, the thickness direction of the pouch film 120 corresponds to the z-axis direction, and the first direction F1 corresponds to a downward direction according to the z-axis direction. That is, in the illustrated embodiment, the first sealing bar 211 may be formed to press the sealing region 140 downward. In correspondence with the first sealing bar 211, the second sealing bar 212 may be formed to press the sealing region 140 in a second direction F2 opposite to the first direction F1. That is, in the illustrated embodiment, the second sealing bar 212 may be formed to press the sealing region 140 upward.

The sealing region 140 may be pressed between the first and second sealing bars 211 and 212. In other words, the sealing region 140 may be pressed in the thickness direction according to the z-axis direction. Accordingly, the pouch film 120, the sealing material 141, and the electrode tab 130 may appropriately come into close contact with each other and be bonded. The pressing of the first and second sealing bars 211 and 212 may be implemented by the relative movement of the first and second sealing bars 211 and 212. For example, the sealing device 210 may be provided to press the sealing region 140 when the second sealing bar 212 approaches the first sealing bar 211, whose position is maintained, to press the sealing region 140 when the first sealing bar 211 approaches the second sealing bar 212, whose position is maintained, or to press the sealing region 140 when the first and second sealing bars 211 and 212 move and approach together. The term “pressure” as used in this description is used to have a meaning including pressure caused by relative movement.

Although not clearly illustrated in FIG. 3, in some embodiments, the sealing device 210 may be formed to extend in a width direction to appropriately press the sealing region 140 in a width direction thereof. In other words, the first sealing bar 211 and the second sealing bar 212 may be formed to appropriately extend in the width direction according to the x-axis direction, from an end portion at one side in the width direction of the sealing region 140 to an end portion at an opposite side corresponding thereto (see FIG. 1).

Meanwhile, in some embodiments, the secondary battery manufacturing device 200 may include the induction heating coil 220. The induction heating coil 220 may be disposed in the outer region 131 of the electrode tab 130 to inductively heat the electrode tab 130. Here, the outer region 131 refers to a portion of the electrode tab 130 that is exposed to the outside of the pouch film 120 as described above with reference to FIG. 2. The induction heating coil 220 may inductively heat the electrode tab 130 in the outer region 131 to provide heat necessary for sealing to the sealing region 140. In other words, the sealing region 140 may be heated through heat transmitted through the induction heating coil 220 or the electrode tab 130. Further, the sealing material 141 may be heated and melted at an appropriate bonding temperature by the sealing region 140 heated in this manner.

In some embodiments, the induction heating coil 220 may be disposed to be spaced a predetermined gap G1 from one surface of the outer region 131. In the illustrated embodiment, the induction heating coil 220 may be disposed below the outer region 131, and accordingly, the induction heating coil 220 may be disposed to be spaced the predetermined gap G1 from a bottom surface of the outer region 131. For example, the induction heating coil 220 may be disposed to be spaced a gap G1 of about 0.5 mm from the bottom surface of the outer region 131. However, in the embodiments of the present disclosure, the gap G1 between the induction heating coil 220 and the outer region 131 is not limited to the exemplified range.

In some embodiments, the induction heating coil 220 may be provided to heat the electrode tab 130 in a non-contact state. In other words, the induction heating coil 220 may be provided to heat the electrode tab 130 through induction heating. Specifically, a high-frequency alternating current may be applied to the induction heating coil 220, and accordingly, a magnetic field having an alternating magnetic flux may be formed around the induction heating coil 220. The magnetic field may induce an eddy current in the electrode tab 130 made of a metal material, and the eddy current may generate Joule heating via resistance within the electrode tab 130 and inductively heat the electrode tab 130 in a non-contact state.

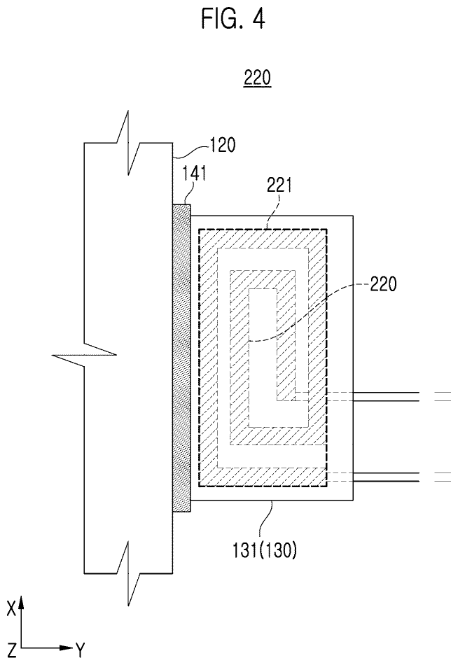

FIG. 4 is a schematic plan view of the induction heating coil illustrated in FIG. 3.

Referring to FIG. 4, in some embodiments, the induction heating coil 220 may form a heating region 221 when viewed from above. The heating region 221 may be defined as a virtual region formed by outer edges of the induction heating coil 220 when viewed from above. In other words, the induction heating coil 220 may extend to form a predetermined curve or pattern when viewed from above, and the induction heating coil 220 extending in this manner may form outer edge regions when viewed from above. In the illustrated embodiment, the induction heating coil 220 extends to form a substantially quadrangular spiral trajectory, and the heating region 221 is formed as a rectangular region formed by the outer edge regions of the induction heating coil.

In some embodiments, the heating region 221 may be disposed inside the outer region 131 of the electrode tab 130 when viewed from above. Further, the heating region 221 may sufficiently extend to occupy more than half of a plane area formed by the outer region 131. In the illustrated embodiment, the outer region 131 of the electrode tab 130 forms a predetermined rectangular region when viewed from above, and the heating region 221 is exemplified as a relatively small rectangular region included inside the rectangular region. The induction heating coil 220 may effectively heat the outer region 131 or the electrode tab 130 through the arrangement of the heating region 221 as described above.

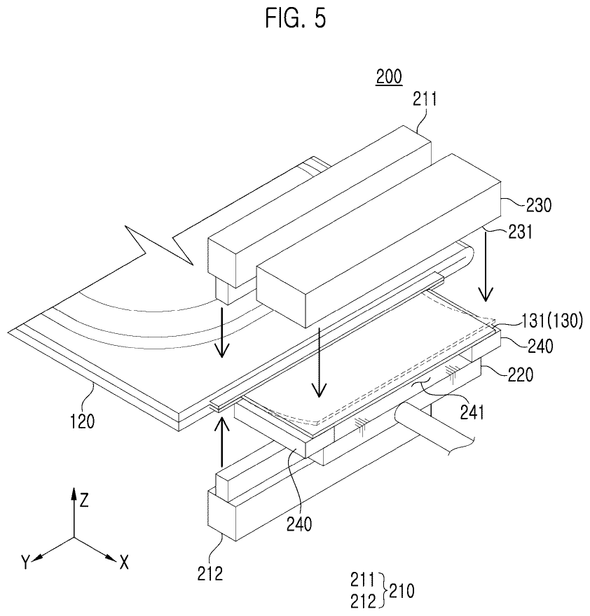

FIG. 5 is a schematic perspective view illustrating first and second guides disposed in the secondary battery manufacturing device illustrated in FIG. 3.

Referring to FIG. 5, in some embodiments, the secondary battery manufacturing device 200 may include a first guide 230. The first guide 230 may be provided to press and support the electrode tab 130 when the electrode tab 130 is inductively heated. Accordingly, the first guide 230 may appropriately limit movement of the electrode tab 130 caused by a magnetic field while performing induction heating. In other words, the first guide 230 may function to maintain the appropriate gap G1 between the outer region 131 of the electrode tab 130 and the induction heating coil 220 while performing induction heating.

In some embodiments, the first guide 230 may be formed to be movable relative to the electrode tab 130. The first guide 230 may be formed to be moved toward the electrode tab 130 to press and support the electrode tab 130, or may be formed to be detachable from the electrode tab 130 in such a supporting state. With respect to mainly describing the illustrated embodiment, the first guide 230 may be formed to be movable relative to the electrode tab 130 upward and downward, and may be moved toward the electrode tab 130 downward to press and fix an outer surface (an upper surface) of the electrode tab 130. Further, the first guide 230 may be moved upward in the above-described state to be detached from the outer surface (the upper surface) of the electrode tab 130.

In some embodiments, the first guide 230 may include a pressing surface 231 that comes into contact with the electrode tab 130 to support the electrode tab 130. In the illustrated embodiment, an example in which the pressing surface 231 is a bottom surface region of the first guide 230 is illustrated. The pressing surface 231 may be formed to extend in a width direction to appropriately cover the electrode tab 130 in a width direction thereof. In other words, in the illustrated embodiment, the electrode tab 130 may have a predetermined width in a left-right direction, and the pressing surface 231 may be formed to extend left and right from an end portion at one side of the electrode tab 130 to an end portion at the other side in a left-right width direction.

In some embodiments, the first guide 230 may include a material such as a non-metallic heat-resistant material. For example, the first guide 230 may partially or entirely include a material such as a heat-resistant polymer such as polyetheretherketone (PEEK), polyphenylene sulfide (PPS), polytetrafluoroethylene (PTFE), etc., or a ceramic material.

Meanwhile, in some embodiments, the secondary battery manufacturing device 200 may include a second guide 240. The second guide 240 may be disposed to face the first guide 230 with the outer region 131 of the electrode tab 130 interposed therebetween. That is, with respect to mainly describing the illustrated embodiment, the first guide 230 may be disposed above the outer region 131, and the second guide 240 may be disposed below the outer region 131 to face the first guide 230 with the outer region 131 interposed therebetween. Further, the second guide 240 may support the outer region 131 between the first guide 230 and the second guide 240. In other words, the outer region 131 may be disposed between the first and second guides 230 and 240 and supported between the first and second guides 230 and 240. An upper surface of the outer region 131 may be supported by the first guide 230, and a bottom surface of the outer region 131 may be supported by the second guide 240 so that the outer region 131 may be disposed above the induction heating coil 220 to form a substantially flat shape.

In some embodiments, the outer region 131 may be disposed so that the predetermined gap G1 is maintained between the outer region 131 and the induction heating coil 220 by the second guide 240. In other words, the second guide 240 may be disposed between the outer region 131 and the induction heating coil 220 to determine the gap G1 between the outer region 131 and the induction heating coil 220. Accordingly, the gap G1 between the outer region 131 and the induction heating coil 220 may be adjusted by the second guide 240. For example, the gap G1 may be adjusted by placing the second guide 240 having a predetermined thickness that is pre-manufactured between the outer region 131 and the induction heating coil 220.

In some embodiments, the second guide 240 may be provided as multiple sets of second guides 240, and each set of the second guides 240 may be formed with different thicknesses. In such a case, the second guide 240 may be appropriately selected and used according to the specific specifications of the outer region 131. For example, the second guide 240 may be appropriately selected and used according to a material of the outer region 131 or electrode tab 130.

Meanwhile, in some embodiments, the second guide 240 may include an opening 241. The opening 241 may be formed to pass through the second guide 240 vertically between the induction heating coil 220 and the outer region 131. In the illustrated embodiment, the opening 241 is formed to vertically pass through a central region of the second guide 240 and divide the second guide 240 left and right. The opening 241 may function as a path for a magnetic field of the induction heating coil 220 to approach the outer region 131. Accordingly, the opening 241 may be formed to extend to have a sufficiently wide area to occupy a significant portion of the outer region 131 when viewed from above. For example, the second guide 240 may form the opening 241 by leaving only a portion of a region supporting left and right edges of the outer region 131 and removing most of the remaining central region as in the illustrated embodiment.

In a similar manner to the first guide 230 described above, the second guide 240 may include a material such as a non-metallic heat-resistant material. For example, the second guide 240 may partially or entirely include a material such as a heat-resistant polymer such as PEEK, PPS, PTFE, etc., or a ceramic material.

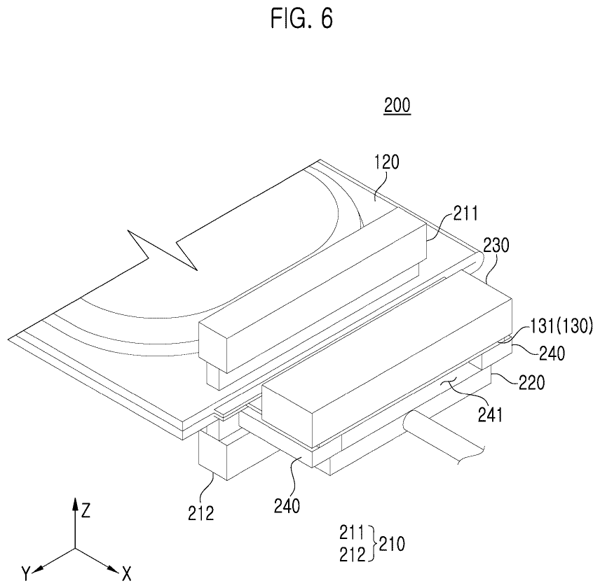

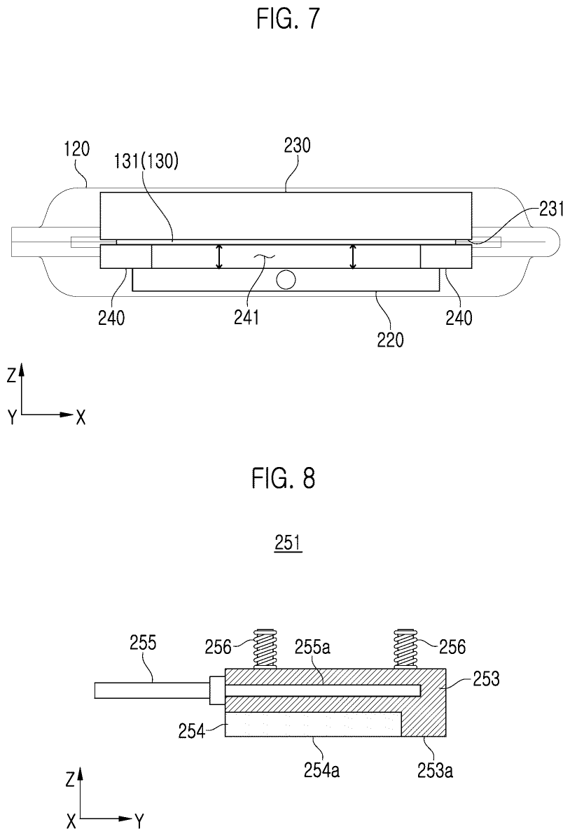

FIG. 6 is a schematic perspective view illustrating operations of the first and second guides illustrated in FIG. 5. FIG. 7 is a schematic front view illustrating the first and second guides illustrated in FIG. 6.

Referring to FIGS. 6 and 7, for bonding of the sealing region 140, the outer region 131 of the electrode tab 130 may be mounted on the second guide 240. Here, a significant area of the bottom surface of the outer region 131 may be exposed to the induction heating coil 220 through the opening 241.

The first guide 230 may be moved down toward the outer region 131 from an initial position thereof as illustrated in FIG. 5. Accordingly, the pressing surface 231 of the first guide 230 may come into contact with an upper surface of the outer region 131 and press the outer region 131. That is, the first guide 230 may press and support the outer region 131. Since the first guide 230 is formed to extend in a left-right width direction, the outer region 131 may be appropriately supported by the first guide 230 in the entire region in the left-right width direction. Further, while the first guide 230 presses and supports the outer region 131, the second guide 240 may maintain an appropriate gap G1 between the outer region 131 and the induction heating coil 220.

In some embodiments, the induction heating coil 220 may inductively heat the electrode tab 130 in a state in which the outer region 131 of the electrode tab 130 is supported by the first and second guides 230 and 240 as described above. That is, when the outer region 131 is supported as described above, a current for induction heating may be applied to the induction heating coil 220.

In some embodiments, the above-described method may limit the displacement of the outer region 131 caused by induction heating, thereby allowing a more accurate amount of heat to be input into the outer region 131 or the electrode tab 130. Specifically, the electrode tab 130 may have a shape of a thin metal sheet, and the electrode tab 130 in the shape of such a metal sheet may interfere with the magnetic field while performing induction heating, thereby causing displacement. That is, the eddy current flowing inside the electrode tab 130 may generate an additional magnetic field, and when such a magnetic field interacts with the magnetic field generated by the induction heating coil 220, an external force may be applied to the electrode tab 130. Such an external force may cause displacement, such as slightly lifting of the electrode tab 130 or the like, and the displacement that occurs may change the predetermined gap G1 between the outer region 131 of the electrode tab 130 and the induction heating coil 220, thereby reducing the heating effect. That is, the predetermined accurate amount of heat cannot be input into the outer region 131 or the electrode tab 130. Some embodiments of the present disclosure may effectively solve such a problem by performing induction heating in a state in which the displacement of the outer region 131 is appropriately limited.

Meanwhile, the sealing device 210 may be operated simultaneously or sequentially along with the induction heating coil 220. For example, the sealing device 210 may be operated to press the sealing region 140 simultaneously with the application of the current to the induction heating coil 220. Alternatively, the sealing device 210 may be operated to press the sealing region 140 after the sealing region 140 is heated for a certain period of time through the induction heating coil 220.

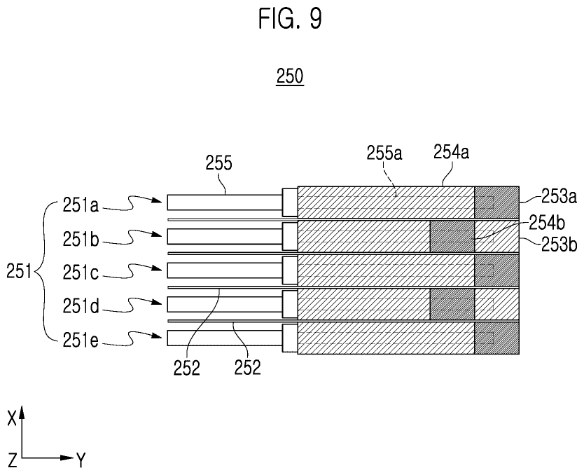

FIG. 8 is a schematic side view illustrating a temperature measurement portion according to one embodiment of the present disclosure. FIG. 9 is a schematic bottom view of the temperature measurement portion illustrated in FIG. 8 as viewed from below.

Referring to FIGS. 8 and 9, in some embodiments, the secondary battery manufacturing device 200 may further include a temperature measurement portion 250. The temperature measurement portion 250 may be disposed to measure a temperature of the electrode tab 130 in real time while performing induction heating. The measured temperature may be used to determine whether the secondary battery manufacturing device 200 is operating appropriately or to adjust an output of the induction heating coil 220.

In some embodiments, the temperature measurement portion 250 may include a plurality of temperature measurement units 251. For reference, in FIG. 8, the temperature measurement portion 250 is illustrated by focusing on one temperature measurement unit 251 according to the direction being illustrated. The plurality of temperature measurement units 251 are illustrated more clearly in FIG. 9. In the illustrated embodiment, five temperature measurement units 251 are illustrated. For convenience, in the following, the respective temperature measurement units 251 are separately referred to as first to fifth temperature measurement units 251a to 251e. The first temperature measurement unit 251a refers to a temperature measurement unit 251a illustrated at the uppermost side in the drawing, and second to fifth temperature measurement units 251b to 251e sequentially refer to temperature measurement units 251b to 251e disposed below the first temperature measurement unit 251a.

In some embodiments, an insulating wall 252 may be provided between the temperature measurement units 251. The insulating wall 252 may be formed between an adjacent pair of temperature measurement units 251 to extend in a front-rear direction. The insulating wall 252 may be partly or entirely formed of an insulating material to insulate the adjacent pair of temperature measurement units 251 from each other. By means of such an insulating wall 252, each temperature measurement unit 251 may obtain a more accurate temperature in each corresponding one of the measurement regions 257a to 257e.

In some embodiments, each temperature measurement unit 251 may include a heat-conducting portion 253 and a heat-insulating portion 254. The heat-conducting portion 253 may be formed of a material having high thermal conductivity. For example, the heat-conducting portion 253 may be partly or entirely formed of a brass material. The heat-insulating portion 254 may be formed of a material having relatively low thermal conductivity. In other words, the heat-insulating portion 254 may be formed of an insulating material. For example, the heat-insulating portion 254 may be partly or entirely formed of an insulating ceramic material.

In some embodiments, the heat-conducting portion 253 may include a first contact surface 253a. In the illustrated embodiment, an example in which the first contact surface 253a is a region of a bottom surface of the heat-conducting portion 253 is described, and the first contact surface 253a forms a region having a substantially rectangular shape when viewed from above. The remaining region of the bottom surface of the heat-conducting portion 253 except for the first contact surface 253a may be appropriately blocked by the heat-insulating portion 254. Accordingly, the heat-conducting portion 253 may conduct heat from the outside in a region corresponding to the first contact surface 253a. A temperature sensor 255 which will be described below may measure a temperature of the heat-conducting portion 253 to measure a local temperature in the region corresponding to the first contact surface 253a.

In some embodiments, the heat-insulating portion 254 may include a second contact surface 254a. The second contact surface 254a may be disposed to correspond to the first contact surface 253a when viewed from above. In other words, the first and second contact surfaces 253a and 254a may be disposed on one identical plane. In the illustrated embodiment, the first and second contact surfaces 253a and 254a are disposed on a region of a bottom surface of the temperature measurement unit 251 and form a region of the bottom surface and a remaining region of the bottom surface of each of the temperature measurement units 251. The second contact surface 254a may function to insulate a remaining region of the heat-conducting portion 253 excluding the first contact surface 253a from the electrode tab 130.

In some embodiments, each temperature measurement unit 251 may include a temperature sensor 255. The temperature sensor 255 may be provided as a thermocouple temperature sensor having a sensor rod 255a. However, in the embodiments of the present disclosure, the type of the temperature sensor 255 is not necessarily limited to the one that has been exemplified. The exemplified temperature sensor 255 may be provided such that the sensor rod 255a is embedded in an interior of the heat-conducting portion 253 to measure an internal temperature of the heat-conducting portion 253. Accordingly, each temperature measurement unit 251 may measure a temperature of the first contact surface 253a corresponding to the heat-conducting portion 253.

In some embodiments, each temperature measurement unit 251 may include an elastic support unit 256. The elastic support unit 256 may be formed to elastically support the first and second contact surfaces 253a and 254a toward an outer surface of the electrode tab 130. The elastic support unit 256 may function as a buffering unit to prevent damage to the electrode tab 130 during a process in which the first and second contact surfaces 253a and 254a come into contact with or are detached from the outer surface of the electrode tab 130. Further, the elastic support unit 256 may contribute to improving the accuracy of temperature measurement by appropriately coming into close contact the first and second contact surfaces 253a and 254a with the outer surface of the electrode tab 130.

Meanwhile, in some embodiments, the first contact surfaces 253a of the temperature measurement units 251 may be disposed at different positions when viewed from above. For example, in the illustrated embodiment, the first contact surface 253a of the first temperature measurement unit 251a is disposed at an upper right position based on the drawing, and the first contact surface 253a of the second temperature measurement unit 251b adjacent thereto is disposed at a lower left position of the first contact surface 253a based on the drawing. Similarly, the first contact surfaces 253a of the third to fifth temperature measurement units 251c to 251e are also disposed to be misaligned with each other in the up and down and left and right directions based on the drawing.

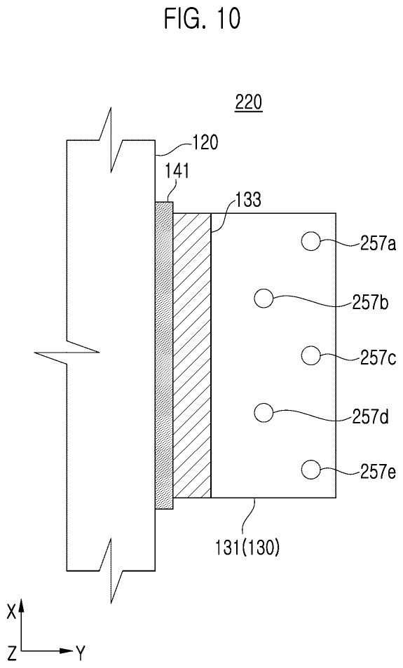

The plurality of temperature measurement units 251 may measure the temperature of the electrode tab 130 in the measurement regions 257a to 257e at different positions when viewed from above according to the position of each first contact surface 253a. Here, the measurement regions 257a to 257e refer to partial regions of the electrode tab 130 in which each temperature measurement unit 251 measures the temperature, and correspond to the position of the first contact surface 253a when viewed from above (see FIG. 10). Preferably, the plurality of temperature measurement units 251 may be provided to measure the temperature of the electrode tab 130 in the measurement regions 257a to 257e that are evenly distributed at a predetermined gap when viewed from above. In other words, the first contact surfaces 253a of the temperature measurement units 251 may be evenly distributed at the predetermined gap with respect to the electrode tab 130 when viewed from above. For example, in the illustrated embodiment, the first contact surfaces 253a of the first to fifth temperature measurement units 251a to 251e are disposed to be misaligned with each other to have a certain gap in the up and down and left and right directions based on the drawing.

Meanwhile, in some embodiments, the temperature measurement portion 250 may be disposed on the first guide 230. For example, the temperature measurement portion 250 may be provided in the form of a component assembled inside the first guide 230. Alternatively, the temperature measurement portion 250 may be disposed in a form in which the temperature measurement portion 250 is partially or entirely integrated into the first guide 230. Further, in some embodiments, the first and second contact surfaces 253a and 254a of each temperature measurement unit 251 may form a plane corresponding to the pressing surface 231 of the first guide 230. In other words, the first and second contact surfaces 253a and 254a may be disposed on the pressing surface 231. In some cases, part or all of the first and second contact surfaces 253a and 254a may be provided to share the function of the pressing surface 231.

FIG. 10 is a schematic plan view illustrating a region measured by the temperature measurement portion illustrated in FIG. 9.

Referring to FIG. 10, the temperature measurement portion 250 may measure a temperature of each region of the electrode tab 130 at a position corresponding to a position of each first contact surface 253a when viewed from above. Specifically, the electrode tab 130 may include a plurality of measurement regions 257a to 257e in the outer region 131, and the temperature measurement portion 250 may be disposed so that each first contact surface 253a corresponds to each of the measurement regions 257a to 257e, and may be provided to measure a temperature of each of the measurement regions 257a to 257e. In some embodiments, the measured temperature may be used to determine whether the electrode tab 130 is heated unevenly or to adjust an output of the induction heating coil 220 to be in an appropriate range.

Meanwhile, in some embodiments, the electrode tab 130 may have a contact restriction region 133 in a predetermined region adjacent to the sealing material 141. The contact restriction region 133 may be required to be a region in which scratches on a surface and the like should be particularly restricted. In such a case, the positions of the measurement regions 257a to 257e of the electrode tab 130 or the positions of the first contact surfaces 253a corresponding thereto when viewed from above may be appropriately disposed within the outer region 131 excluding the contact restriction region 133.

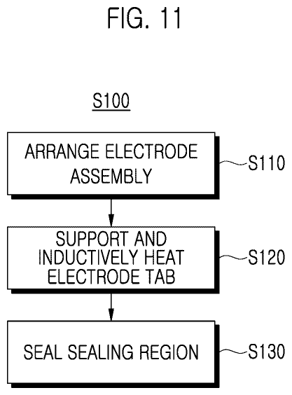

FIG. 11 is a schematic process diagram illustrating a secondary battery manufacturing method according to one embodiment of the present disclosure.

According to another aspect of the present disclosure, a secondary battery manufacturing method S100 may be provided. In some embodiments, the secondary battery manufacturing method S100 may include a method of sealing between an pouch film 120 and an electrode tab 130 in a secondary battery 100 having a pouch-type form factor. In some embodiments, the secondary battery manufacturing method S100 may be implemented using the secondary battery manufacturing device 200 of the above-described embodiment. However, the present disclosure is not necessarily limited thereto. In some other embodiments, the secondary battery manufacturing method S100 may be implemented through a different device from the secondary battery manufacturing device 200 of the above-described embodiment. Hereinafter, for convenience, a case in which the secondary battery manufacturing method S100 is implemented using the secondary battery manufacturing device 200 of the above-described embodiment will be mainly described.

Referring to FIG. 11, in some embodiments, the secondary battery manufacturing method S100 may include an operation (a) (S110) in which an electrode assembly 110 is disposed inside an pouch film 120, an operation (b) (S120) in which the electrode tab 130 is inductively heated by an induction heating coil 220 disposed in an outer region 131 while a first guide 230 presses and supports the outer region 131 of the electrode tab 130, and an operation (c) (S130) in which a sealing region 140 disposed inside the pouch film 120 is pressed and sealed simultaneously or sequentially along with the operation (b).

Specifically, in some embodiments, the secondary battery manufacturing method S100 may include the operation (a) in which the electrode assembly 110 is disposed inside the pouch film 120 (hereinafter, referred to as an “electrode assembly placement operation S110”). For example, in the electrode assembly placement operation S110, the electrode assembly 110 and the pouch film 120 may be disposed as illustrated in FIG. 5 described above.

In some embodiments, the secondary battery manufacturing method S100 may include the operation (b) in which the electrode tab 130 is inductively heated while the first guide 230 presses and supports the outer region 131 of the electrode tab 130 (hereinafter, referred to as an “induction heating operation S120”). For example, in the induction heating operation S120, the outer region 131 of the electrode tab 130 may be supported by the first guide 230 as illustrated in FIGS. 6 and 7 described above. Further, in the induction heating operation S120, the outer region 131 of the electrode tab 130 may be inductively heated by the induction heating coil 220 disposed therebelow as illustrated in FIGS. 6 and 7 described above. Further, in the induction heating operation S120, the outer region 131 of the electrode tab 130 may be supported by the first guide 230 as illustrated in FIGS. 6 and 7 described above, and thus the upward movement or displacement caused by a magnetic field may be appropriately limited.

In some embodiments, the secondary battery manufacturing method S100 may include the operation (c) in which the sealing region 140 disposed inside the pouch film 120 is pressed and sealed (hereinafter, referred to as a “sealing region sealing operation S130”). For example, in the sealing region sealing operation S130, the sealing region 140 may be sealed between first and second sealing bars 211 and 212 as illustrated in FIG. 3 described above. Further, the sealing region sealing operation S130 may be performed simultaneously or sequentially along with the induction heating operation S120.

Meanwhile, in some embodiments, the induction heating operation S120 may include an operation in which the outer region 131 of the electrode tab 130 is supported between the first guide 230 and the second guide 240. For example, in the induction heating operation S120, the outer region 131 of the electrode tab 130 may be supported between the first guide 230 and the second guide 240 as illustrated in FIGS. 6 and 7 described above.

Further, in some embodiments, the induction heating operation S120 may be performed in a state in which the outer region 131 of the electrode tab 130 is supported between the first and second guides 230 and 240. Here, an opening 241 may be provided in the second guide 240, and a magnetic field for induction heating may be provided to the outer region 131 of the electrode tab 130 through such an opening 241. Accordingly, the outer region 131 of the electrode tab 130 may be appropriately inductively heated through the opening 241 in a state in which the displacement toward the upper side is limited by the first guide 230 and the displacement toward the lower side is appropriately limited by the second guide 240. In other words, the outer region 131 of the electrode tab 130 may be appropriately inductively heated through the opening 241 in a state in which the lifting is limited by the first guide 230 and the second guide 240 maintains a predetermined gap G1 with the induction heating coil 220.

As described above, the embodiments of the present disclosure may provide secondary battery manufacturing equipment and a secondary battery manufacturing method.

Some embodiments of the present disclosure may be used to appropriately seal between an pouch film and an electrode tab in a secondary battery in which an electrode assembly is accommodated in an interior of the pouch film. Some embodiments of the present disclosure may implement more complete sealing of the sealing region by providing heat to a sealing region between the pouch film and the electrode tab. Further, some embodiments of the present disclosure may effectively cope with a reduction in a size of an electrode tab or a reduction in a heat transfer area resulting therefrom by implementing more complete sealing of the sealing region.

Further, some embodiments of the present disclosure may include an induction heating coil and may be implemented to inductively heat an electrode tab and provide heat necessary for sealing. Such an induction heating method may contribute to reducing a heating time for sealing the electrode tab. Further, such an induction heating method may be performed in a non-contact manner to reduce heat loss and may contribute to providing a more accurate amount of heat compensation to the sealing region according to process conditions and the like.

Further, some embodiments of the present disclosure may be implemented in a non-contact manner in which external heat does not come into direct contact with an electrode tab. Accordingly, some embodiments of the present disclosure may reduce surface damage to the electrode tab. Further, some embodiments of the present disclosure may also contribute to reducing the deviation in sealing strength by adjusting an output of an induction heating coil according to a material, design shape, etc. of the electrode tab.

Further, some embodiments of the present disclosure may contribute to improving the sealing quality and strength of the sealing region between the pouch film and the electrode tab. Accordingly, some embodiments of the present disclosure may implement appropriate sealing quality and strength in a secondary battery with increased thickness for improving energy density. Further, some embodiments of the present disclosure may contribute to improving the internal pressure performance for vents and the like that occur during long-term use of a secondary battery.

Embodiments of the present disclosure can provide secondary battery manufacturing equipment and a secondary battery manufacturing method.

Some embodiments of the present disclosure can be used to appropriately seal between an pouch film and an electrode tab in a secondary battery in which an electrode assembly is accommodated in an interior of the pouch film.

Further, some embodiments of the present disclosure can function to seal between the pouch film and the electrode tab through induction heating.

Further, some embodiments of the present disclosure can reduce surface damage to the electrode tab during a sealing process.

Further, some embodiments of the present disclosure can improve the quality of sealing between the pouch film and the electrode tab.

The content described above is merely examples of applying the principles of the present disclosure, and other configurations may be further included without departing from the scope of the present disclosure.

While the embodiments of the present disclosure have been described above, various changes and modifications may be made by those skilled in the art by adding, changing, deleting, or adding components within the scope without departing from the spirit and scope of the present disclosure described in the claims, and these are also included in the scope of the present disclosure.

What is claimed is:

1. Secondary battery manufacturing equipment comprising:
a sealing device configured to press an pouch film to seal a sealing region in which an electrode tab is disposed;
an induction heating coil configured to inductively heat the electrode tab to provide heat to the sealing region in an outer region of the electrode tab disposed outside the pouch film; and
a first guide configured to press and support the electrode tab in a direction opposite to the induction heating coil to limit movement of the electrode tab caused by a magnetic field when the electrode tab is inductively heated.

2. The secondary battery manufacturing equipment of claim 1, wherein the electrode tab includes an inner region disposed inside the pouch film to correspond to the outer region, and
the sealing region is formed in the inner region.

3. The secondary battery manufacturing equipment of claim 1, wherein the sealing device is formed to press a sealing material disposed between the electrode tab and the pouch film in the sealing region, and
at least a portion of the sealing material is melted by the heat transmitted from the electrode tab.

4. The secondary battery manufacturing equipment of claim 1, wherein the sealing device includes:
a first sealing bar that presses the sealing region in a first direction according to a thickness direction of the pouch film; and
a second sealing bar that presses the sealing region in a second direction opposite to the first direction to correspond to the first sealing bar.

5. The secondary battery manufacturing equipment of claim 1, wherein the induction heating coil is disposed to be spaced a predetermined gap from one surface of the outer region.

6. The secondary battery manufacturing equipment of claim 1, wherein the induction heating coil forms a heating region when viewed from above, and
the heating region is disposed on an inner side of the outer region when viewed from above.

7. The secondary battery manufacturing equipment of claim 1, wherein the first guide is formed to be movable in a direction approaching an outer surface of the electrode tab or in a direction away from the outer surface of the electrode tab.

8. The secondary battery manufacturing equipment of claim 1, wherein the first guide includes a pressing surface that comes into contact with the electrode tab to support the electrode tab, and
the pressing surface is formed to extend in a width direction according to a width direction of the electrode tab, from an end portion at one side of the electrode tab to an end portion at the other side.

9. The secondary battery manufacturing equipment of claim 1, wherein the first guide is formed to press and support the electrode tab before a current is applied to the induction heating coil.

10. The secondary battery manufacturing equipment of claim 1, further comprising a second guide that is disposed to face the first guide with the outer region interposed therebetween and supports the outer region between the first guide and the second guide.

11. The secondary battery manufacturing equipment of claim 10, wherein the second guide is disposed between the outer region and the induction heating coil to determine a gap between the outer region and the induction heating coil.

12. The secondary battery manufacturing equipment of claim 10, wherein the second guide includes an opening through which a magnetic field of the induction heating coil approaches the outer region.

13. The secondary battery manufacturing equipment of claim 1, further comprising a temperature measurement portion configured to measure a temperature of the electrode tab in real time while performing induction heating.

14. The secondary battery manufacturing equipment of claim 13, wherein the temperature measurement portion includes a plurality of temperature measurement units disposed on the first guide, and
the plurality of temperature measurement units are formed to measure the temperature of the electrode tab in each of different measurement regions when viewed from above.

15. The secondary battery manufacturing equipment of claim 14, wherein the temperature measurement portion includes an insulating wall that is disposed between the respective temperature measurement units and insulates the respective temperature measurement units from each other.

16. The secondary battery manufacturing equipment of claim 13, wherein the temperature measurement portion includes one or more temperature measurement units, and
the temperature measurement units include:
a heat-conducting portion having a first contact surface in contact with the electrode tab;
a heat-insulating portion that has a second contact surface corresponding to the first contact surface and insulates the electrode tab from the heat-conducting portion; and
a temperature sensor that is embedded in the heat-conducting portion and measures a temperature of the heat-conducting portion.

17. The secondary battery manufacturing equipment of claim 16, wherein the temperature measurement portion includes a plurality of temperature measurement units,
any one of the plurality of temperature measurement units includes the first contact surface provided at a predetermined position when viewed from above, and
another one of the plurality of temperature measurement units includes the first contact surface at a different position from the predetermined position when viewed from above.

18. A secondary battery manufacturing method comprising:
an operation (a) of arranging an electrode assembly inside an pouch film;
an operation (b) of inductively heating an electrode tab using an induction heating coil disposed in an outer region while a first guide presses and supports the outer region of the electrode tab; and
an operation (c) of pressing and sealing a sealing region disposed inside the pouch film simultaneously or sequentially along with the operation (b).

19. The secondary battery manufacturing method of claim 18, wherein the operation (b) includes an operation of supporting the outer region between the first guide and a second guide corresponding to the first guide, and
the operation (b) includes an operation of providing a magnetic field for induction heating to the outer region through an opening provided in the second guide.

20. The secondary battery manufacturing method of claim 19, wherein the operation (b) includes an operation of supporting the outer region between the first guide and the second guide corresponding to the first guide, and
the operation (b) includes an operation of inductively heating the electrode tab while the second guide maintains a gap between the outer region and the induction heating coil.
